(19) United States
(12) Patent Application Publication
(10) Pub. No.: US 2007/0137939 A1
(43) Pub. Date: Jun. 21, 2007

(54) Magnetic oil injecting device

(76) Inventor: Jobee Liu, Wujie Township (TW)

Correspondence Address: LOWE HAUPTMAN BERNER, LLP, 1700 DIAGONAL ROAD, SUITE 300, ALEXANDRIA, VA, 22314, US

(21) Appl. No.: 11/284,037

(22) Filed: Nov. 22, 2005

(51) Int. Cl. F16N 11/06

(52) U.S. Cl. 184/46; 184/74

(57) ABSTRACT

A magnetic oil injecting device is composed of a seat which is provided with an oil loop, a first groove, and an S-pole magnetic plate latched into the first groove; an oil package, whose outer periphery is provided with projection members and concave members, and which is provided with a top surface and a lower connection end connected to a concave part; and an N-pole magnetic plate which is attached to the top surface of oil package. By an effect of magnetic flux of the S-pole magnetic plate and the N-pole magnetic plate, a mutually attractive force is generated to create a compression motion to the oil package, so as to uniformly squeeze out oil, thereby eliminating a conventional way of using an external power, motor, piston, and mechanical transmission as an oil squeezing element.

### BACKGROUND OF THE INVENTION

a) Field of the Invention

The present invention relates to a magnetic oil injecting device, and more particularly to a magnetic single-point oil injecting device for lubricating a bearing.

b) Description of the Prior Art

A previous oil injector for lubricating a bearing or other machine part is disclosed in the Taiwan Utility Model Publication No. 193310, “Automatic Oil Injector,” and 205875, “Single-Point Oil Supply Machine,” wherein an external electric power or interior storage battery should be used to provide a power source to drive a motor to move a piston, so as to squeeze an oil out of the oil injector for lubricating the bearing or machine part. However, as the interior of oil injector is occupied by transmission elements such as the motor, gears, screws; therefore, a volume of oil package is greatly decreased and the oil will be used up in a short time of usage, such that the oil package should be replaced, which wastes a lot of manpower and material.

As the power is controlled by the motor, battery, or external electric energy, a power back-out, or a damage of electric conducting (storage) element and transmission element will all cause an interruption of oil supply. More particularly, a noise caused by starting the motor and screws and a corrosion of battery will be interfering with the environment.

### SUMMARY OF THE INVENTION

The primary object of present invention is to provide a magnetic oil injecting device which compresses an oil package to uniformly squeeze out the oil, so as to eliminate a conventional way of using an external power, motor, piston, and mechanical transmission as a oil squeezing element, by a magnetic effect of N-pole and S-pole magnetic plates located above and below an oil package.

Another object of the present invention is to provide a magnetic oil injecting device having a large space for installing the oil package, so as to emplace a larger oil package.

Still another object of the present invention is to provide a magnetic oil injecting device which will not generate a noise during operation, thereby facilitating an environmental protection.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of elements of the present invention before being assembled.

FIG. 2 shows a cross sectional view of the present invention.

FIG. 3 shows a cross sectional view of a motion of the present invention.

FIG. 4 shows a cross sectional view of another motion of the present invention.

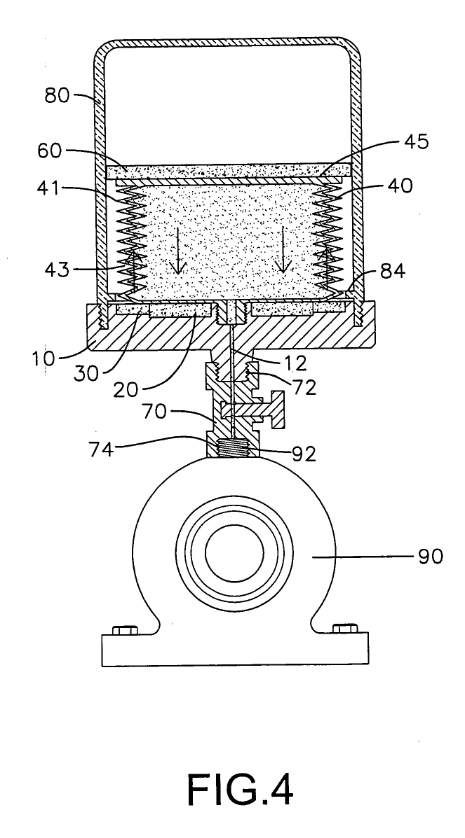

FIG. 5 shows a cross sectional view of the present invention not having an outer cover.

FIG. 6 shows a cross sectional view of another implementation of the present invention.

### DETAILED DESCRIPTION OF THE PREFERRED EMBODIMENTS

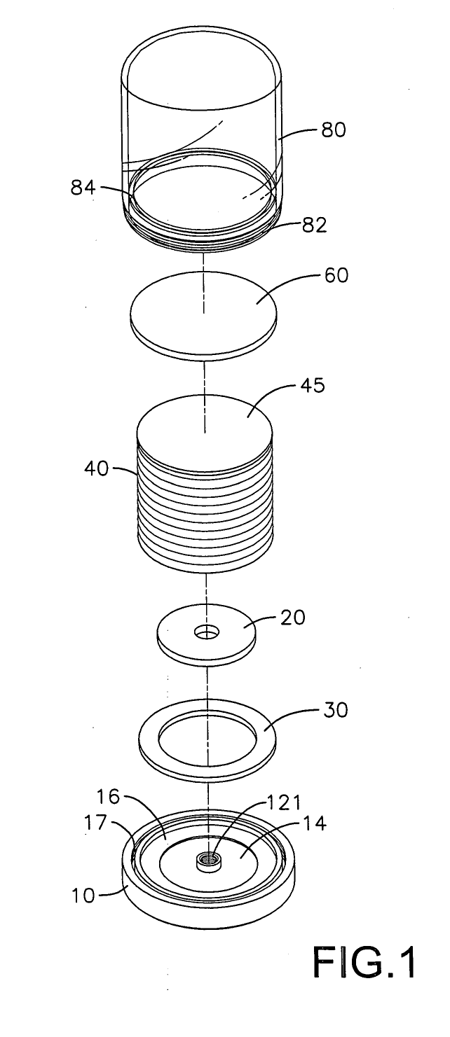

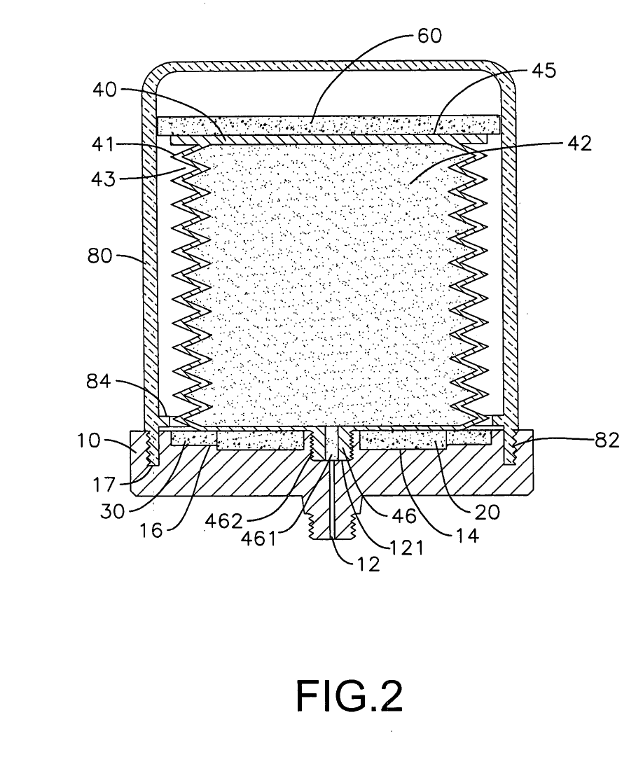

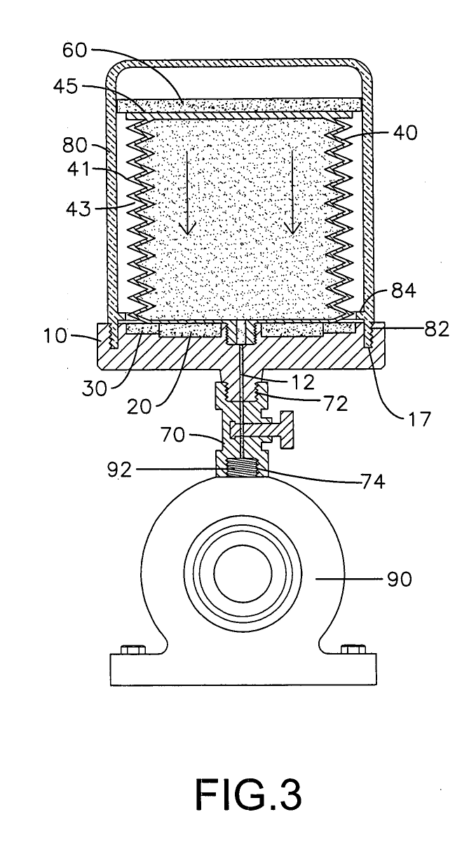

Referring to FIG. 1, FIG. 2, and FIG. 3, the present invention is to provide a magnetic oil injecting device comprising a seat 10 whose center is provided with a longitudinal oil loop 12 above which is provided with a concave part 121 for connection, with a first groove 14 located along an external periphery of the concave part 121, and an S-pole magnetic plate 20 latched into the first groove 14; an oil package 40 whose interior is filled with an oil 42, whose external periphery is provided with continuous projection members 41 and concave members 43 to form a compressible state for the oil package 40, and which is provided with a top surface 45 and whose bottom end forms a lower connection end 46 having a lower outlet 461 and being connected to the concave part 121, with the lower outlet 461 connected to the oil loop 12; an N-pole magnetic plate being attached to a top surface of oil package 40; and a flow control valve 70 whose connection end 72 is connected to the oil loop 12, for controlling a quantity and an on/off state of oil coming out of the oil loop 12.

By an effect of magnetic flux of the S-pole magnetic plate 20 and the N-pole magnetic plate 60, a mutually attractive force is generated to create a compression motion to the oil package 40.

Referring to FIG. 1 and FIG. 2, a second groove 16 is located at an outer edge of the first groove 14, and an N-pole magnetic plate 30 can be emplaced into the second groove 16.

Referring to FIG. 1, FIG. 2, and FIG. 3, a connecting slot 17, which is a screw-hole, is located at an edge on a surface of seat 10, and threads 82 are located at a bottom end of outer cover 80 such that the outer cover 80 can be screwed in the connecting slot 17 for covering the oil package 40.

Referring to FIG. 1 and FIG. 2, the protruded lower connection end 46 is provided with external threads 462, and the circular concave part 121 is provided with an inner screw-hole, such that the lower connection end 46 can be screwed into the concave part 121.

Referring to FIG. 3, an outlet end 74 of the flow control valve 70 is connected to a connection end 92 on a bearing 90.

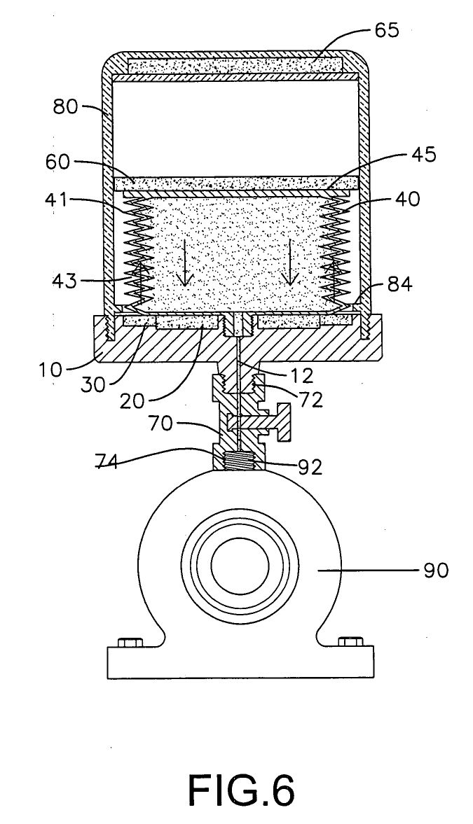

Referring to FIG. 6, an N-pole magnetic plate 65 can be fixed on a top of the outer cover 80 such that a repulsive force can be generated between the N-pole magnetic plate 65 and the N-pole magnetic plate 60 on the top surface 45 of oil package 40.

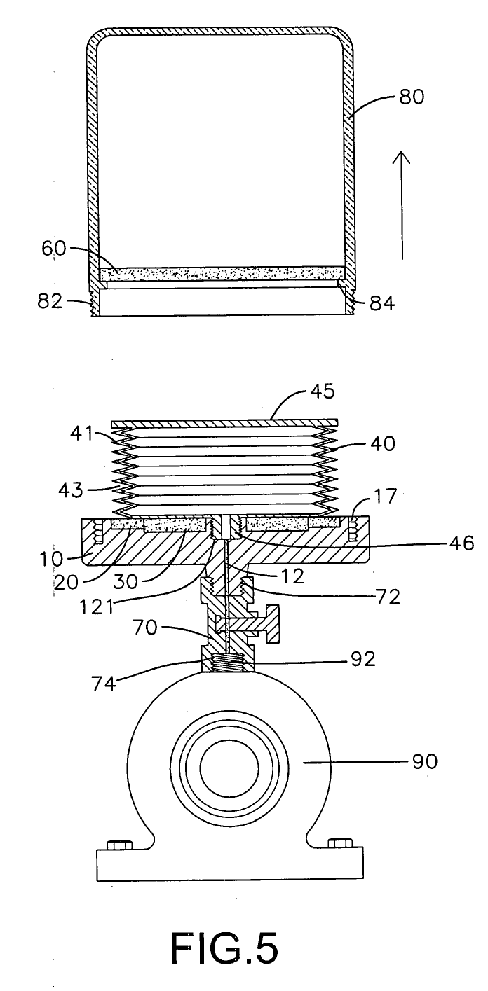

Referring to FIG. 1 and FIG. 5, a projection ring 84 is located on an inner wall of a lower side of the outer cover 80.

Referring to FIG. 1 and FIG. 2, an N-pole magnetic plate 60, which is a permanent magnet, is attached on a top surface 45 of oil package 40 and its magnetic strength (magnetic flux density) is 4500 Gauss in this implementation. An S-pole magnetic plate 20 is also provided with a magnetic strength of 4500 Gauss. A distance between the N-pole magnetic plate 60 and the S-pole magnetic plate 20 is about 65 mm, which is a height of oil package 40. When the distance between the N-pole magnetic plate 60 and the S-pole magnetic plate 20 is 65 mm, a mutually attractive force of 1 kg/cm2 will be generated, and the closer the in-between distance is, the larger the attractive force between the two magnetic plates is. The oil package 40 is a plastic container which can be filled with oil 42, and its outer surface is provided with a design of continuous V-shaped projection members 41 and V-shaped concave members 43, such that the oil package 40 is gradually compressed by a mutually attractive force between the N-pole and S-pole magnetic plates 60, 20. When the oil package 40 is compressed to the height of 15 mm, the attractive force reaches to a maximum value of 3 kg/cm2. At this moment, another N-pole magnetic plate 30 is at a magnetic strength of 2400 Gauss, and is generating a magnetic force between the aforementioned N-pole and S-pole magnetic plates 60, 20. When the N-pole magnetic plate 60 on the top descends to about 30 mm (i.e., the oil package 40 is compressed to about 30 mm in height), the repulsive force from the N-pole magnetic plate 30 can offset the attractive force between the N-pole and S-pole magnetic plates 60, 20 which is getting stronger, thereby effectively controlling a uniformity of compression speed of the oil package 40.

Another way of controlling a flow speed of oil 42 which feeds from the lower outlet 461 to the oil loop 12 is through a moment of force of the compressed oil package 40 and a flow control valve 70. As an inner diameter of the oil loop 12 is a constant, the moment of force (as described above) of the compressed oil package 40 can also be effectively controlled, so as to effectively control a flow speed and flow rate of the oil 42 in the oil loop 12 having the constant inner diameter. On the other hand, the flow control valve 70 is another controller of flow speed and flow rate of the oil 42, and can control a size of the oil loop 12 or its on/off state, which means a control of whether the oil is flowing out (on) or not (off); therefore, an on/off timed control valve can also be used.

Referring to FIG. 3, an outlet end 74 of control valve 70 is screwed on an upper connection end 92 of a bearing 90, and the upper connection end 72 is connected on the oil loop 12. By a design of two N-pole magnetic plates 60, 30 and an S-pole magnetic plate 20, along with a design of control valve 70, the oil 42 flowing out of the oil loop 12 and passing through a passage in the control valve 70 can lubricate the bearing 90 at a fixed rate or time.

Referring to FIG. 5, an outer cover 80 is a transparent cylinder and can be separated with the seat 10 and be lifted up, by rotating the outer cover 80. At this moment, the oil 42 in the oil package 40 could have been used up, and the oil package 40 should be replaced with a new one. Upon lifting up the outer cover 80, as a projection ring 84 is latched to the N-pole magnetic plate 60, the N-pole magnetic plate 60 which is attached to an interior of outer cover 80 is lifted up simultaneously with the outer cover 80. By rotating the oil package 40 in an opposite direction, the lower connection end 46 can be separated from the concave part 121; therefore, the oil package 40 whose oil 42 is used up can be taken out for replacing with a new oil package 40. At this time, the N-pole magnetic plate 30 and the S-pole magnetic plate 20 are fixed in the first and second grooves 14, 16; therefore, when a magnetic field occurs at the N-pole and S-pole magnetic plates 30, 20, they will not be shifted.

Referring to FIG. 6, in order to cope with a larger oil package 40, an N-pole magnetic plate 65 can be fixed and enclose on a top of the transparent outer cover 80 for increasing a moment of force of the compressed oil package 40. As the polarity of N-pole magnetic plate 65 is the same as that of the N-pole magnetic plate 60 on the top surface 45 of oil package 40, a repulsive force is created, so as to increase a compression force from top to bottom of the oil package 40.

Accordingly, a power source for compressing the oil is a magnetic field but not a device such as a battery, motor, chemical, or spring. The present invention can increase a reliability of the oil flowing in the loop and is provided with an improvement in environmental protection.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A magnetic oil injecting device comprising a seat whose center is provided with a longitudinal oil loop above which includes a concave part for connection, with a first groove located along an external periphery of the concave part, and an S-pole magnetic plate latched into the first groove; an oil package whose interior is filled with an oil, whose external periphery is provided with continuous projection members and concave members to form a compressible state for the oil package, and which is provided with a top surface and whose bottom end forms a lower connection end having a lower outlet and being connected to the concave part, with the lower outlet connected to the oil loop; an N-pole magnetic plate being attached to a top surface of oil package; an a flow control valve whose connection end is connected to the oil loop, for controlling a quantity and an on/off state of oil coming out of the oil loop; by an effect of magnetic flux of the S-pole magnetic plate and the N-pole magnetic plate, a mutually attractive force being generated to create a compression motion to the oil package.

2. The magnetic oil injecting device according to claim 1, wherein a second groove is located at an outer edge of the first groove, and an N-pole magnetic plate can be emplaced into the second groove.

3. The magnetic oil injecting device according to claim 1, wherein a connecting slot, which is a screw-hole, is located at an edge of a surface of seat, and threads are located at a bottom end of outer cover such that the outer cover can be screwed in the connecting slot for covering the oil package.

4. The magnetic oil injecting device according to claim 1, wherein the protruded lower connection end is provided with external threads, and the circular concave part is provided with an inner screw-hole, such that the lower connection end can be screwed into the concave part.

5. The magnetic oil injecting device according to claim 1, wherein an outlet end of the flow control valve is connected to a connection end on a bearing.

6. The magnetic oil injecting device according to claim 3, wherein an N-pole magnetic plate can be fixed on a top of the outer cover, such that a repulsive force can be generated between the N-pole magnetic plate and the N-pole magnetic plate on the top surface of oil package.

7. The magnetic oil injecting device according to claim 3, wherein a projection ring is located on an inner wall of a lower side of the outer cover.
